(19) United States
(12) Patent Application Publication
(10) Pub. No.: US 2011/0240744 A1
(43) Pub. Date: Oct. 6, 2011

(54) ANTENNA SUBSTRATE AND RFID TAG

(75) Inventor: Nagahisa FURUTANI, Kawasaki (JP)

(73) Assignee: FUJITSU LIMITED, Kawasaki-shi (JP)

(21) Appl. No.: 13/073,471

(22) Filed: Mar. 28, 2011

(30) Foreign Application Priority Data
Mar. 31, 2010 (JP) 2010-81721

(51) Int. Cl. G06K 19/077; H01Q 1/36; G06K 19/02

(52) U.S. Cl. 235/488; 343/787

(57) ABSTRACT

An antenna substrate is provided with a conductor layer, a soft magnetic layer, a patch layer, and a dielectric layer. The soft magnetic layer is disposed on the conductor layer. The patch layer includes a plurality of electromagnetic band gap electrodes which are two-dimensionally arranged on the soft magnetic layer. The dielectric layer is disposed on the patch layer.

### CROSS-REFERENCE TO RELATED APPLICATION

This application is based upon and claims the benefit of priority of Japanese Patent Application No. 2010-81721, filed on Mar. 31, 2010, the entire contents of which are incorporated herein by reference.

### FIELD

Embodiments discussed herein are related to an antenna substrate and an RFID tag.

### BACKGROUND

To date, there have been known various RFID tags which include an antenna pattern formed on antenna substrates and a circuit chip that performs wireless communication via the antenna pattern.

An RFID tag can be attached on commercial products to be managed. Alternatively, an RFID tag can be integrated into a cellular phone to perform wireless communication which is different from telephone communication of the cellular phone. In these types of usage of the RFID tag, the RFID tag can be placed in the vicinity of metal objects. However, in case of a PET film or the like as an antenna substrate, wireless communication can be interrupted due to metal objects.

Recently, an electromagnetic band gap (EBG) structure has been proposed as a structure having characteristics for regularly reflecting incident radio waves. If the EBG structure can be implemented into the antenna substrate of the RFID tag, the RFID tag is expected to enhance wireless communication performance irrespective of adjacent metal objects (refer to U.S. Pat. No. 6,262,495 and Japanese Patent Laid-Open Publication No. 2009-33324, for example).

However, in a case of practically implementing the EBG structure in the RFID tag, desired electromagnetic characteristics can have trouble because of size limitation. Specifically, even if an EBG structure for the RFID tag is designed to obtain a desired bandwidth, the thickness of the antenna substrate of the RFID tag becomes too large for practical use. In other words, when the size including thickness of the antenna substrate is designed suitable for an RFID tag, the bandwidth for desired electromagnetic characteristics becomes too narrow.

### SUMMARY

According to an embodiment of the invention, an antenna substrate is provided with a conductor layer, a soft magnetic layer, a patch layer, and a dielectric layer. The soft magnetic layer is disposed on the conductor layer. The patch layer includes a plurality of electromagnetic band gap electrodes which are two-dimensionally arranged on the soft magnetic layer. The dielectric layer is disposed on the patch layer.

It is to be understood that both the foregoing general description and the following detailed description are exemplary and explanatory, and are not restrictive of the invention.

### BRIEF DESCRIPTION OF DRAWINGS

FIGS. 1A and 1B illustrate a first embodiment of an RFID tag.

FIGS. 2A and 2B illustrate a second embodiment of an RFID tag.

FIG. 3 is a graph illustrating the electromagnetic characteristics of an EBG structure.

FIG. 4 is an explanatory illustration of an EBG structure used for the simulation of a regular reflection band.

FIG. 5 is a graph illustrating the simulation results of a first comparative example.

FIG. 6 is a graph illustrating the simulation results of a second comparative example.

FIG. 7 is a graph illustrating the simulation results for an EBG structure employing a soft magnetic layer.

### DESCRIPTION OF EMBODIMENTS

Hereinafter, embodiments of an antenna substrate and an RFID tag are described with reference to the attached drawings.

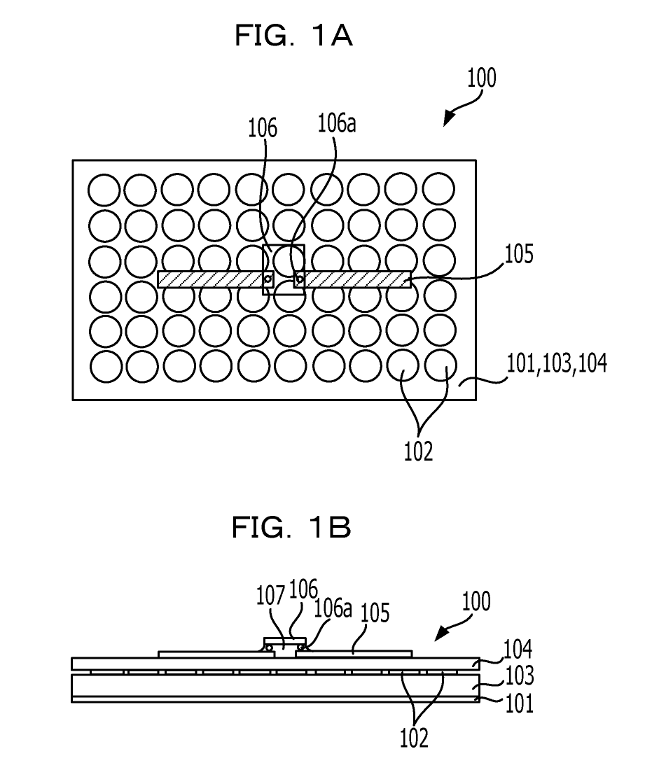

FIGS. 1A and 1B illustrate a first embodiment of an RFID tag.

FIG. 1A is an upper perspective view of an RFID tag of a first embodiment viewed from above, and FIG. 1B is a side perspective view of the RFID tag of the first embodiment viewed from the side.

An RFID tag 100 illustrated in FIGS. 1A and 1B includes an antenna substrate having an EBG structure. Specifically, the RFID tag 100 includes a ground layer 101, EBG electrodes 102, a soft magnetic layer 103, and a dielectric layer 104. The combination of the ground layer 101, the EBG electrodes 102, the soft magnetic layer 103, and the dielectric layer 104 may correspond to an example of the antenna substrate according to the first embodiment. The structure which is formed by the combination of the ground layer 101, the EBG electrodes 102, and the soft magnetic layer 103 can be an EBG structure.

The ground layer 101 is a layer formed of a metal. The ground layer 101 corresponds to an exemplary conductor layer of the present invention. A plurality of the EBG electrodes 102 are two-dimensionally arranged over the ground layer 101, thereby forming an electrode array. In the present embodiment, round electrodes are employed as the EBG electrodes 102. In the present embodiment, the array of the EBG electrodes 102 is a grid array made up of mutually orthogonal rows and columns. This layer formed of the array of the EBG electrodes 102 corresponds to an exemplary patch layer of the present invention. The soft magnetic layer 103 is a layer formed of a soft magnetic material. The soft magnetic material used in the present embodiment is composite ferrite formed by mixing ferrite particles into a resin material. In an ordinary EBG structure, the EBG electrodes 102 are electrically connected to the ground layer 101 using vias. However, in the present embodiment, unlike the ordinary structure, the EBG electrodes 102 are insulated from the ground layer 101 by the soft magnetic layer 103. The dielectric layer 104 is a layer formed of a dielectric material. The dielectric material used in the present embodiment is a PET film. Examples of other usable dielectric materials include epoxies and alumina. The dielectric layer 104 need not be a single layer, and may be a composite layer made up of a plurality of dielectric layers made of different materials.

The RFID tag 100 includes an antenna substrate having the structure described above. The dielectric layer 104 has an antenna pattern 105 formed thereon. That is, the upper surface of the dielectric layer 104 is a surface on which the antenna pattern 105 is mounted. In the present embodiment, the antenna pattern 105 is formed of copper. As another example, the antenna pattern 105 may be formed by printing conductive ink mixed with, for example, silver paste on a film. The antenna pattern 105, which functions as an antenna for radio communication, is a dipole antenna in the present embodiment. Examples of usable antenna patterns other than a dipole antenna include a loop antenna.

The antenna pattern 105 has a circuit chip 106 arranged thereon. The circuit chip 106 is fixed to the antenna pattern 105 and the dielectric layer 104 using an adhesive 107. The circuit chip 106 is connected to the antenna pattern 105 through bumps 106a. The circuit chip 106 performs radio communication through the antenna pattern 105. Although the EBG electrodes 102 are illustrated as having a round shape in the present embodiment, in actual applications, electrodes may be used which are shaped like squares, rectangles, polygons, or the like corresponding to representative unit cells described later for evaluating the EBG characteristics.

Hereinafter, the structure of an RFID tag of a second embodiment is described.

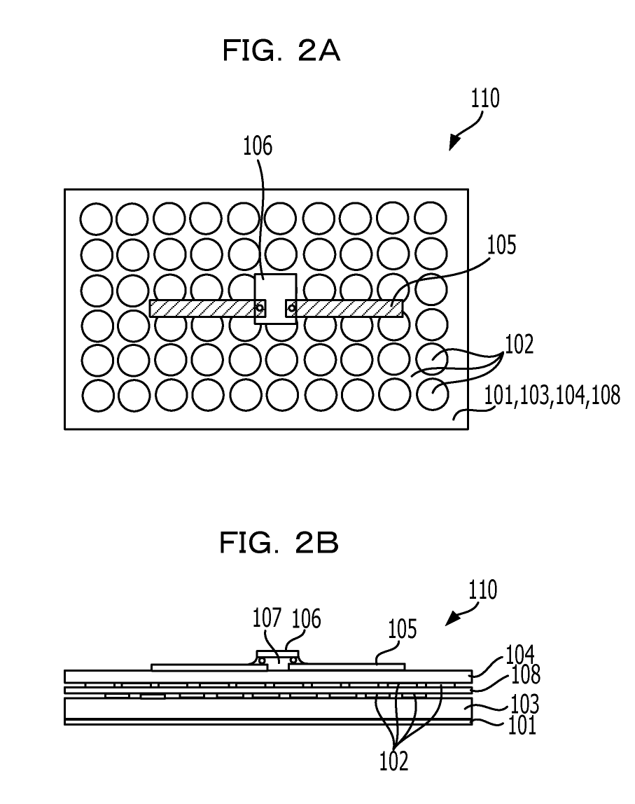

FIGS. 2A and 2B illustrate the RFID tag of the second embodiment.

FIG. 2A is an upper perspective view of the RFID tag of the second embodiment viewed from above, and FIG. 2B is a side perspective view of the RFID tag of the second embodiment viewed from the side.

Among the components included in an RFID tag 110 of the second embodiment illustrated in FIGS. 2A and 2B, components similar to those included in the RFID tag 100 of the first embodiment illustrated in FIGS. 1A and 1B are denoted by the same reference numerals, and repeated description is omitted.

The RFID tag 110 illustrated in FIGS. 2A and 2B also includes an antenna substrate having an EBG structure. Specifically, the combination of the ground layer 101, the EBG electrodes 102, the soft magnetic layer 103, the dielectric layer 104, and an intermediate soft magnetic layer 108 corresponds to the second embodiment of the antenna substrate. In the second embodiment, the structure formed by the combination of the ground layer 101, the EBG electrodes 102, the soft magnetic layer 103, and the intermediate soft magnetic layer 108 is an EBG structure. The EBG structure in the second embodiment includes two EBG electrode layers with the intermediate soft magnetic layer 108 therebetween. Although the EBG electrodes 102 are illustrated as having a round shape in the present embodiment, in actual applications, electrodes may be used which are shaped like squares, rectangles, polygons, or the like corresponding to representative unit cells described later for evaluating the EBG characteristics.

Hereinafter, the electromagnetic characteristics of an EBG structure are described.

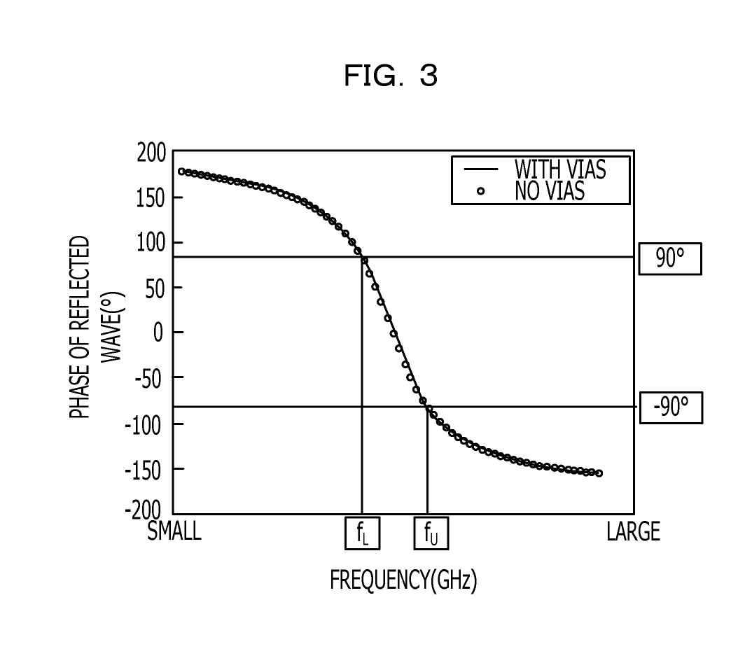

FIG. 3 is a graph illustrating the electromagnetic characteristics of an EBG structure.

The horizontal axis in FIG. 3 represents the frequency of an incident wave which is incident to the EBG structure from above. The vertical axis represents the phase of a reflected wave which has been reflected from the EBG structure upward.

In general, an EBG structure shows the characteristics illustrated by the solid line in FIG. 3. That is, the phase of a reflected wave, which is about 180 degrees when an incident wave has a low frequency, decreases to below 90 degrees, and then becomes negative after 0 degrees as the frequency of the incident wave increases. Then the phase of the reflected wave, going below −90 degrees, asymptotically approaches −180 degrees as the frequency of the incident wave further increases. It can be said that the frequency band of the incident wave for which the phase of the reflected wave is in a range between 90 degrees and −90 degrees is a frequency band for which the EBG structure shows regular reflection. Hereinafter, this frequency band is called a regular reflection band. In addition, the frequency of the incident wave at which the reflected wave shows a phase of 90 degrees is called a lower limit frequency f_{L} of the regular reflection band, and the frequency of the incident wave at which the reflected wave shows a phase of −90 degrees is called an upper limit frequency f_{U} of the regular reflection band.

The EBG structure has a band gap for electromagnetic waves in this regular reflection band. In other words, electromagnetic waves having a frequency within the regular reflection band cannot penetrate into the EBG structure in principle, and hence are totally reflected.

Accordingly, when an antenna substrate having an antenna provided thereon has an EBG structure and communication is performed using a frequency within the regular reflection band, the antenna substrate becomes a perfect electromagnetic shield and the communication waves are even increased due to total reflection.

In order to preferably apply such characteristics provided by an EBG structure to an RFID tag, it is necessary to design the EBG structure such that the frequency band of the communication waves used in the RFID tag matches or widely overlaps the regular reflection band. Hence, by designing an EBG structure using a material that has been proposed, the regular reflection band of the designed EBG structure was simulated.

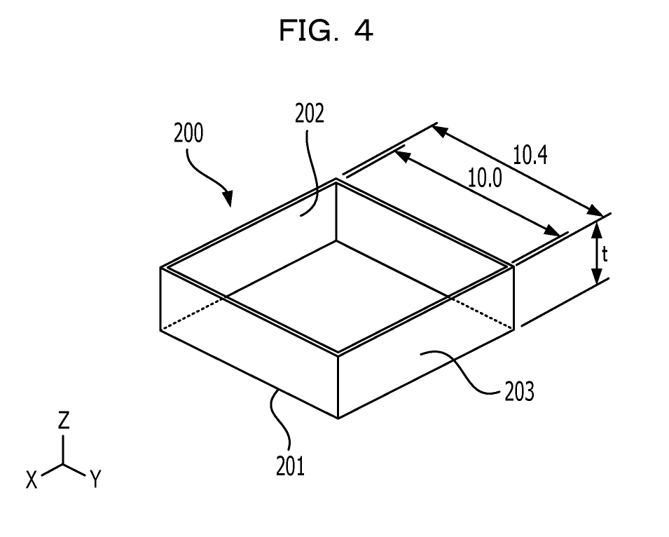

FIG. 4 is an illustration for explaining the EBG structure used for simulation of the regular reflection band.

FIG. 4 illustrates a basic cell 200 of the EBG structure. The EBG structure is formed by arranging the basic cells 200 continuously in the X-direction and Y-direction of the XYZ coordinate system illustrated in FIG. 4. The basic cell 200 includes a ground layer 201 made of a metal, a cell electrode 202 made of a metal, a dielectric layer 203 sandwiched between the ground layer 201 and the cell electrode 202. Both the ground layer 201 and the cell electrode 202 are shaped like squares, but the cell electrode 202 is slightly smaller (smaller by 0.4 mm in the example illustrated in the figure) than the ground layer 201. Hence, when the basic cells 200 are connected, the ground layers 201 form a single continuous wide ground layer, but the cell electrodes 202 form an electrode array, where the electrodes are separated from one another. Note that although the cell electrode 202 having a square shape was used in the simulation for computational convenience, the basic property of the EBG structure is nearly the same as that in the case of a round electrode.

A case in which an epoxy substrate material (with a specific dielectric constant of 4.4) is used as the dielectric layer 203 of the basic cell 200 was simulated as a first comparative example. A case in which alumina (with a specific dielectric constant of 10.2) is used as the dielectric layer 203 of the basic cell 200 was simulated as a second comparative example. It was assumed that an incident wave is incident from the Z direction of the XYZ coordinate system illustrated in FIG. 4. The simulation results illustrated in the graphs below are the simulation results in the case of the 10.4 mm by 10.4 mm basic cell 200 including the 10 mm by 10 mm cell electrode 202 with a thickness t as a parameter, as illustrated in FIG. 4. The sizes of the basic cell 200 and the cell electrode 202 are sizes required to make the distance between an antenna and an antenna substrate having the basic cells 200 continuously arranged thereon be roughly 1 mm. A smaller electrode is required if the antenna substrate is to be arranged closer to the antenna substrate.

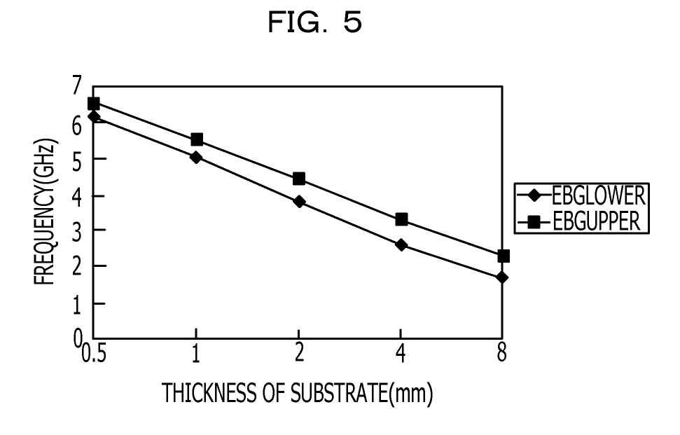

FIG. 5 is a graph illustrating the simulation results of the first comparative example.

In this graph, the horizontal axis represents the thickness of the basic cell, i.e., the thickness of the substrate. The vertical axis represents the frequency of an incident wave. The line with diamond symbols represents the lower limit frequency f_{L} described above, and the line with square symbols represents the upper limit frequency f_{U} described above. In other words, the frequency band between these lines is the regular reflection band.

RFID tags typically use communication waves having frequencies lower than 2 GHz. As can be seen from FIG. 5, the regular reflection band does not reach 2 GHz or below in the first comparative example unless the thickness of the substrate is 8 mm or more. Hence, it can be seen that, in the first comparative example, an antenna substrate having a practical thickness as an RFID tag is not obtained.

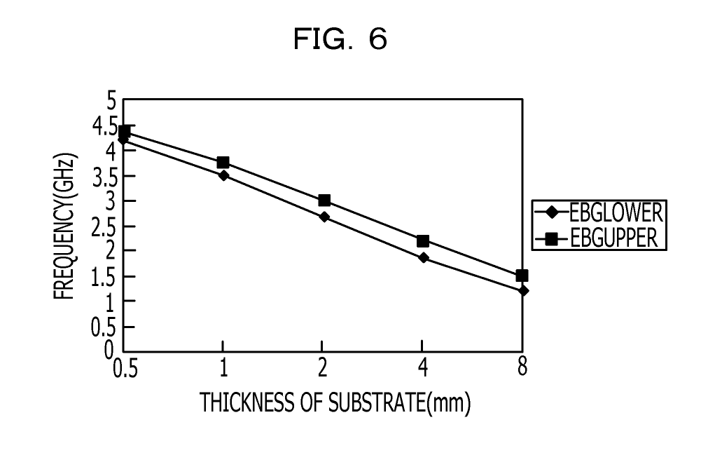

FIG. 6 is a graph illustrating the simulation results of the second comparative example.

In FIG. 6, the vertical axis, the horizontal axis, the line with diamonds symbols, and the line with square symbols represent the same things as those in FIG. 5.

Although the specific dielectric constant in the second comparative example is double the specific dielectric constant in the first comparative example or more, it can be seen that there is not a big difference in the simulation results. In other words, the regular reflection band does not reach 2 GHz or below unless the thickness of the substrate is 4 mm or more.

Continued designing and testing was performed so as to obtain a regular reflection band at 2 GHz or less by changing parameters other than the thickness of the substrate, and determined that smaller electrodes are better. However, it turned out that the width of the regular reflection band decreases as the electrode size is decreased, and as a result, a practical bandwidth is not obtained. In addition, designing and testing were continued regarding the shape of a via connecting the ground layer to the electrode so as to change an L component generated between the ground layer and the electrode. This via is considered to be essential for the EBG structure proposed to date. However, it was determined that the electromagnetic characteristics negligibly change even when the shape of the via is greatly changed. Furthermore, it was determined that the electromagnetic characteristics negligibly change even when the via is completely removed, which is contrary to common belief. In FIG. 3, the electromagnetic characteristics of an EBG structure including vias are illustrated using a solid line, and the electromagnetic characteristics of the EBG structure without vias are illustrated using round symbols. As is clear from FIG. 3, the electromagnetic characteristics of the EBG structure are negligibly influenced by whether or not vias exist.

Through further designing and testing, it was determined that by arranging a high-magnetic-permeability material, especially a soft magnetic material, between the ground layer and the electrode, an antenna substrate having excellent electromagnetic characteristics is obtained.

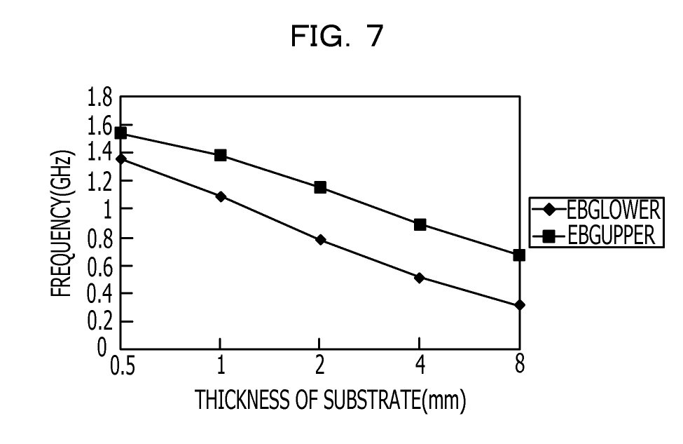

FIG. 7 is a graph illustrating the simulation results for an EBG structure which employs a soft magnetic layer.

Also in this graph, the vertical axis, the horizontal axis, the line with diamond symbols, and the line with square symbols represent the same things as those in FIG. 5. Further, also in this simulation, a basic cell having the same size as the basic cell 200 illustrated in FIG. 4 was used.

The soft magnetic material employed in this simulation has a specific dielectric constant of 8.8 and a specific magnetic permeability of 10.0. Such physical properties are easily obtained through preparation of the composite ferrite described above.

As is clear from the graph illustrated in FIG. 7, a regular reflection band at or below 2 GHz is obtained with a practical substrate having a thickness of 1 mm or less. Furthermore, the obtained bandwidth of the reflection band is a practical bandwidth of 200 MHz or more.

The embodiments described above will be again described on the basis of the simulation results thus obtained.

The RFID tag 100 of the first embodiment illustrated in FIG. 1 includes the soft magnetic layer 103 between the ground layer 101 and the EBG electrodes 102. Due to this structure, a regular reflection band at or below 2 GHz is realized with a practical thickness in the RFID tag 100 of the first embodiment. Hence, even when a metal object exists below the RFID tag 100 in FIGS. 1A and 1B, the RFID tag 100 can normally perform communication over a wide bandwidth.

Further, the RFID tag 100, which has an EBG structure in which the EBG electrodes 102 are insulated from the ground layer 101 by the soft magnetic layer 103, has a simplified structure. Hence, its manufacturing process is also simplified, resulting in a reduction in cost.

Further, since composite ferrite is used as the material of the soft magnetic layer 103 in the RFID tag 100, the soft magnetic layer 103 having desired physical properties can be easily realized, and versatility required for RFID tags is also realized.

In the RFID tag 110 of the second embodiment illustrated in FIG. 2, since the multi-layered EBG electrodes 102 are employed, communication is possible at frequencies lower than those used for the RFID tag 100 of the first embodiment. Further, since soft magnetic layers are provided among the plurality of layers of the EBG electrodes 102, a thin antenna substrate is realized. Note that the distances among the plurality of layers of the EBG electrodes 102 are much smaller than the distance between the ground layer 101 and the EBG electrodes 102. Hence, in the case in which a relatively thick substrate is allowed, a structure in which simple dielectric layers exist among the layers of the EBG electrodes 102 may be selected as a design alternative.

All examples and conditional language recited herein are intended for pedagogical objects to aid the reader in understanding the invention and the concepts contributed by the inventors to further the art, and are to be construed as being without limitation to such specifically recited examples and conditions, nor does the organization of such examples in the specification relate to a showing of the superiority and inferiority of the invention. Although the embodiments of the invention have been described in detail, it will be understood by those of ordinary skill in the relevant art that various changes, substitutions, and alterations could be made hereto without departing from the spirit and scope of the invention as set forth in the claims.

What is claimed is:

1. An antenna substrate, comprising:
a conductor layer;
a soft magnetic layer disposed on the conductor layer;
a patch layer including a plurality of electromagnetic band gap electrodes two-dimensionally arranged on the soft magnetic layer; and
a dielectric layer disposed on the patch layer.

2. The antenna substrate according to claim 1, wherein the soft magnetic layer includes composite ferrite of which ferrite particles are mixed in a resin material.

3. The antenna substrate according to claim 1, wherein the antenna substrate has a regular reflection band at or below 2 GHz.

4. The antenna substrate according to claim 3, wherein the antenna substrate has at least 200 MHz bandwidth of the regular reflection band.

5. The antenna substrate according to claim 1, wherein the soft magnetic layer has a specific dielectric constant of 8.8 and a specific magnetic permeability of 10.0.

6. The antenna substrate according to claim 1, wherein the conductor layer comprises a ground layer.

7. The antenna substrate according to claim 1, wherein the soft magnetic layer electrically insulates the conductor layer from the patch layer.

8. An antenna substrate, comprising:
a conductor layer;
a first soft magnetic layer disposed on the conductor layer;
a first patch layer including a plurality of electromagnetic band gap electrodes two-dimensionally arranged on the first soft magnetic layer;
a second soft magnetic layer disposed on the first patch layer; and
a second patch layer including a plurality of electromagnetic band gap electrodes two-dimensionally arranged on the second soft magnetic layer; and
a dielectric layer disposed on the second patch layer.

9. The antenna substrate according to claim 8, wherein the second soft magnetic layer is interposed between the first and second patch layers.

10. The antenna substrate according to claim 8, wherein the second soft magnetic layer includes composite ferrite of which ferrite particles are mixed in a resin material.

11. The antenna substrate according to claim 8, wherein the conductor layer comprises a ground layer.

12. An RFID tag comprising:
a conductor layer;
a soft magnetic layer disposed on the conductor layer;
a patch layer including a plurality of electromagnetic band gap electrodes two-dimensionally arranged on the soft magnetic layer;
a dielectric layer disposed on the patch layer;
an antenna pattern formed on the dielectric layer; and
a circuit chip connected to the antenna pattern, said circuit chip configured to perform wireless communication through the antenna pattern.
